(19) United States
(12) Patent Application Publication
(10) Pub. No.: US 2010/0299994 A1
(43) Pub. Date: Dec. 2, 2010

(54) METHOD AND DEVICE FOR CARING FOR VEGETATION LAYERS

(76) Inventor: Winfried Kneussle, Weingarten (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/788,964

(22) Filed: May 27, 2010

(30) Foreign Application Priority Data
May 29, 2009 (DE) 10 2009 023 271.0

(51) Int. Cl. A01G 1/00

(52) U.S. Cl. 47/1.1 R; 47/58.1 SC

(57) ABSTRACT

To care for vegetation layers, fluid is injected into them by means of at least one membrane hose laid underground. This fluid is a liquid/gas mixture, like, for example, a water/air mixture or a water/oxygen mixture, so that the vegetation layers can be given an optimal supply of moisture and oxygen any time.

### BACKGROUND TO INVENTION

Conventional above-ground watering and mechanical aeration, thatching and the like are generally used to care for vegetation layers such as grass, athletic fields, gardens and parks, farmland, forests and the like. To prevent the known disadvantages of overhead irrigation, namely the evaporation of large quantities of water, poor root formation and soil compaction, underground irrigation systems are increasingly being used.

Good aeration and a corresponding water supply are known to be essential prerequisites for the development of good ground vegetation. It turns out that the pore space in the ground has a key function here, since it is responsible for the ecologically critical functions of drainage, aeration and water storage. The coarse pores basically handle drainage and subsequent aeration, while the medium pores handle storage. The function that the respective pores assume depends decisively on their diameter and hence their capillary strength. If the capillary strength is greater than the gravitational pull, the water is held in the ground (medium pores); if, on the other hand, it is less than the gravitational pull, the water flows into the subsoil and leaves the pore space free for gas exchange (coarse pores). For drainage and aeration to work, the pores must also be connected to one another and to the surface of the soil or the atmosphere (pore intercommunication). With new vegetation layers, like newly constructed athletic fields, for example, pore size distribution and pore intercommunication must be well adjusted and guaranteed by corresponding installation specifications.

Problems with, for example, the base layer of grass do not normally occur until after it has been in use for some time. Extreme mechanical stresses during games on grass athletic fields over time result in adverse changes in the structure of the soil and/or pore space. This is generally called “compaction” of the soil. Typical features of this type of compacted soil are standing water on the surface of the soil and, in the medium term, a reduction in grass quality. The reason for this is permanent damage in the coarse pore area, where the drainage function is largely lost. The standing water in turn stops the gas exchange, and the result is anaerobic soil conditions that can kill the vegetation in the soil.

The advantages of well aerated soil can be explained as follows. In naturally growing soil, the growth of the root length decreases continually with the depth of the soil, since the coarse pore area naturally decreases with the soil depth, and hence the gas exchange, and as a result root growth decreases. If air is steadily added to the soil at the corresponding depths, there is a clear increase in root growth.

Underground systems that can be aerated can be used instead. As soon as the gas exchange over the surface is hindered because of soil compaction, such systems can inject the missing oxygen into the anaerobic areas by adding air or by forced aeration. That way, the soil medium will become fully aerobic again, or it will be kept fully aerobic. Root growth will be stimulated, so that the parts of the plants above the ground experience no loss of quality. Uniform penetration of the soil with fresh air from below is thus superior to above-ground aeration measures, where the oxygen has trouble getting into the soil from the edge of the puncture.

Furthermore, constant use of vegetation layers, like games on grass athletic fields, requires constant repetition of above-ground aeration measures, since the highest stress, i.e., compaction, occurs on the surface. Underground systems, on the other hand, are installed deep down where, as a rule, there is no longer any basic compaction, so the air can spread out from these systems continuously without being affected.

With good root growth, the shearing strength of the substrate also increases. This can also be promoted by underground irrigation through upward capillary action. Advantageously, only the reservoir in the soil is refilled (result: saves water), and the coarse pore area remains permanently free for aeration. When they are watered above ground, the plants develop a primarily flat root system, while underground irrigation forces the plants to tap deeply and the roots to grow toward the water. This forced deep tapping also has a very positive effect on turf areas.

Another positive aspect of underground systems is the synergy effect from the simultaneous use of grass heating. Thermal transport in the ground is essentially based on the movement of water in the soil. With underground systems, the heat rises, preferably by capillary action. In contrast, there is no convective heat transport downward caused by drainage and cooling due to cold, draining surface water.

An underground aeration system is known, for example from DE 38 29 560 A1. This system furnishes oxygen to the plant root area using membrane hoses laid underground.

The inventor has also developed the so-called OSMO-DRAIN® System. The basic design and function of this OSMO-DRAIN® system are described in detail, for example, in DE 101 37 147 A1 and DE 202 11 742 U1.

The systems disclosed in these two documents contain an arrangement of membrane hoses laid underground that are permeable to fluids, a coupling element connected to the membrane hoses with a first connection to carry a liquid under pressure to the membrane hoses and a second connection to extract liquid and/or gases from the membrane hoses by vacuum, as well as a control unit to control this coupling element, in order to connect the membrane hoses optionally to the first or second connection of the coupling element. The coupling element can also come with a third connection for a compressed air source. The control unit is preferably connected to different sensors and probes so the system can be controlled automatically.

Unlike earlier plant-care systems, this OSMO-DRAIN® System uses only one single hose or hose system to permit both irrigation and drainage, degassing and/or aeration of a vegetation layer by providing the option of allowing the membrane hose to be connected to the first connection to hold liquid under pressure, the second connection to extract liquid and gases by vacuum or the third connection to move air under pressure in or out of the hose system. The hose is designed as a membrane hose, i.e., a porous hose, which allows fluids like water or gases to flow through it in both directions.

If the membrane hose is connected to a pressurized liquid intake, the liquid is pressed through the porous walls of the hose into the surrounding earth of the vegetation layer. With this first connection of the coupling element to the vegetation layer, if necessary, additional materials can be mixed into the pressurized water added. In the same way, when the membrane hose is connected to a pressurized air or oxygen intake, the air or oxygen can be injected into the surrounding earth through the porous walls of the hose. In the case of a vacuum connection, the excess water in the surrounding earth and/or the manure gas produced as a result of waterlogging, for example, is sucked into the hose through the porous walls of the membrane hose and then carried off by the hose system.

This system also provides the option of heating the vegetation layer since hot water or hot air can be supplied to the hose system under pressure through the first or third connection.

Besides the OSMO-DRAIN® System itself, the inventor has also developed a method of laying membrane hoses for such a system underground and a device for doing so.

With the method described in EP 1 811 218 A1, first a rotating cutting device is used to cut one or more slits in the ground to a depth of at least the installation depth of the membrane hose and a width less than or equal to the diameter of the membrane hose, and the earth is simultaneously loosened by alternating transverse movements, at least in the area where the membrane is installed. Then, the slits that were cut are widened using a widening device to a width at least the diameter of the membrane hose; and finally, a membrane hose is laid in the widened slits from a holding device by a laying device.

Since only relatively narrow slits are cut in the ground in the first step, any already existing vegetation layer is not damaged. Simultaneously loosening the earth when the slits are cut counteracts compaction, so that the capillarity action necessary for the plant-care system in the soil next to the membrane hose is guaranteed. In addition, the slits cut are widened to the diameter of the membrane hose, so that the membrane hose laid in this widened slit has the desired close contact with the adjacent soil. The membrane hose can easily be laid automatically or semiautomatically, and the existing grass or the like will be protected or not damaged when the hose system is laid, so that it can be fully usable again shortly after the installation of the OSMO-DRAIN® System.

As already mentioned above, the membrane hose system laid underground has the advantage that it can also be used to heat the soil or vegetation layers. The membrane hose system is thus superior to conventional grass heating, since not only the soil in the area directly surrounding the heating hose is heated. Rather, hot water or hot air under pressure can be injected into the soil and transported upward by capillary action through the porous area in the soil.

### SUMMARY OF THE INVENTION

The invention is based on the problem of creating an improved method and an improved device for taking care of vegetation layers that allow ideal care of vegetation layers with liquid and oxygen.

According to a first aspect of the invention, this problem is solved by a method of caring for vegetation layers in which fluid is taken to the vegetation layers by means of at least one membrane hose laid underground. According to the invention, this fluid is a liquid/gas mixture.

Because of the underground intake to the vegetation layers, the fluid is made directly available to the root area of the plants. As described above, this has several advantages compared to aboveground irrigation and mechanical aeration. According to the invention, now a liquid/water mixture is taken to the vegetation layers. That way, unlike the conventional methods, moisture and oxygen can be added to the vegetation layers at the same time. This is an advantage in that it can prevent the earth from meanwhile drying out or becoming waterlogged, and the plants always receive an ideal supply of moisture and oxygen.

A “membrane hose” is a hose that allows fluids (liquids and gases) to go through it in both directions. It can be flexible and bendable or rigid, and is preferably composed of a chemically and physically resistant plastic or rubber material (for example, old tire granulate).

In one embodiment of the invention, the liquid/gas mixture is produced by mixing a gas with a liquid. This mixing of a gas and a liquid can be done, for example, by means of a so-called water aerator, which is known in various embodiments in the state of the art.

The liquid/gas mixture can be produced, for example, by injecting a gas into a stream of liquid or by entraining a gas through a stream of liquid.

The liquid/gas mixture is preferably a water/air mixture or a water/oxygen mixture.

In one embodiment of the invention, additional materials (for example, fertilizer, pest-control products and the like) can be mixed in with the liquid/gas mixture.

In another embodiment of the invention, the liquid/gas mixture can be tempered before being injected into the vegetation layers. In addition or alternatively, the liquid/gas mixture can also be tempered basically during the entire intake path to the vegetation layers.

The term “tempering” is taken to mean warming or heating and cooling, as well as staying in a certain temperature range.

In another embodiment of the invention, the pressure of the liquid/gas mixture can be set or controlled at a certain value or range of values.

According to a second aspect of the invention, the problem above is solved by a device for taking care of vegetation layers, which has at least one membrane hose laid underground to carry a fluid to the vegetation layers and a supply unit connected to at least one membrane hose. The invention proposes that the supply unit have at least one device for preparing a liquid/gas mixture.

With this device, the same advantages in caring for vegetation layers can be achieved as were mentioned above in connection with the method in the invention.

In one embodiment of the invention, the device for preparing a liquid/gas mixture is a device for mixing gas and liquids. It can have, for example, a first connection to inject a liquid under pressure and a second connection to inject a gas —depending on the embodiment with or without pressure —into the stream of liquid.

The device for preparing a liquid/gas mixture can be built into the supply unit, for example. Alternately, the supply unit can also have a connection to connect the device for preparing the liquid/gas mixture to the supply unit.

In another embodiment of the invention, the device for preparing a liquid/gas mixture is designed so that it provides the option of only a liquid or only a gas. This can increase the flexibility of the plant-care system for different applications and environmental conditions.

The liquid/gas mixture is preferably a water/air mixture or a water/oxygen mixture.

In one embodiment of the invention, the supply unit can also have at least one or more connections, which are selected from a connection for taking in a liquid under pressure, a connection for taking in a gas under pressure and a connection for removing liquids and/or gases by vacuum in or out of at least one membrane hose.

In another embodiment of the invention, the supply unit can also be provided with an (internal or external) tempering device for tempering the fluid that goes into at least one membrane hose. That way, the fluids can be taken into the vegetation layers in a temperature range that is ideal for their care.

In yet another embodiment of the invention, at least one membrane hose can basically be provided with a tempering device over its entire length. This measure can make sure that the fluids transported through the membrane hose over long distances can be output at basically the same temperature from the membrane hose into the surrounding earth. As a result, the vegetation layers can be uniformly tempered using a membrane hose equipped this way over an extended range.

Furthermore, a device for adding an additional material (for example, fertilizer, pest control product and the like) can be provided with the fluid added to at least one membrane hose. This additive device enhances the functionality of the plant-care system and/or allows it to be adjusted to the respective environmental conditions.

In another embodiment of the invention, the supply unit and/or the device for preparing a liquid/gas mixture also have a pressure regulator to regulate or control the pressure of the fluid added to the vegetation layers. With such a pressure regulator, the pressure of the fluid added to the vegetation layers can be adjusted so that the fluid is made available over the entire plant-care area to the vegetation layers as uniformly as possible.

In yet another embodiment of the invention, the supply unit and/or the device for preparing a liquid/gas mixture can also have a filtering device to filter the fluid added to the vegetation layers.

Furthermore, at least one membrane hose can also be connected to the supply unit via a distribution device. This distribution device is made of non-porous hoses or pipe, for example.

### DESCRIPTION OF DRAWINGS

The features, advantages and potential applications of the invention above and others will be better understood from the following description of preferred, non-limiting examples of embodiment that refer to the attached drawings.

FIG. 1 is a schematic view of the design of a sample system for caring for vegetation layers according to this invention;

FIG. 1A is an enlarged, schematic partial view of a supply unit of the system shown in FIG. 1, in an alternative embodiment,

FIG. 2 is a schematic view of the membrane hoses in the system in FIG. 1 laid underground;

FIG. 3 is an enlarged sectional view of the membrane hose in the first example of embodiment of the invention;

FIG. 4 is an enlarged sectional view of the membrane hose in the second example of embodiment of the invention;

FIG. 5 is a highly schematic side view of a device for laying membrane hoses underground to install the system shown in FIG. 1 in the first example of embodiment, and

FIG. 6 is a highly schematic side view of a device for laying membrane hoses underground to install the system shown in FIG. 1 in the second example of embodiment.

### DETAILED DESCRIPTION OF THE INVENTION

The present application claims priority to German patent application no. 10 2009 023 271.0, filed on May 29, 2009, the entire contents of which are incorporated herein by reference.

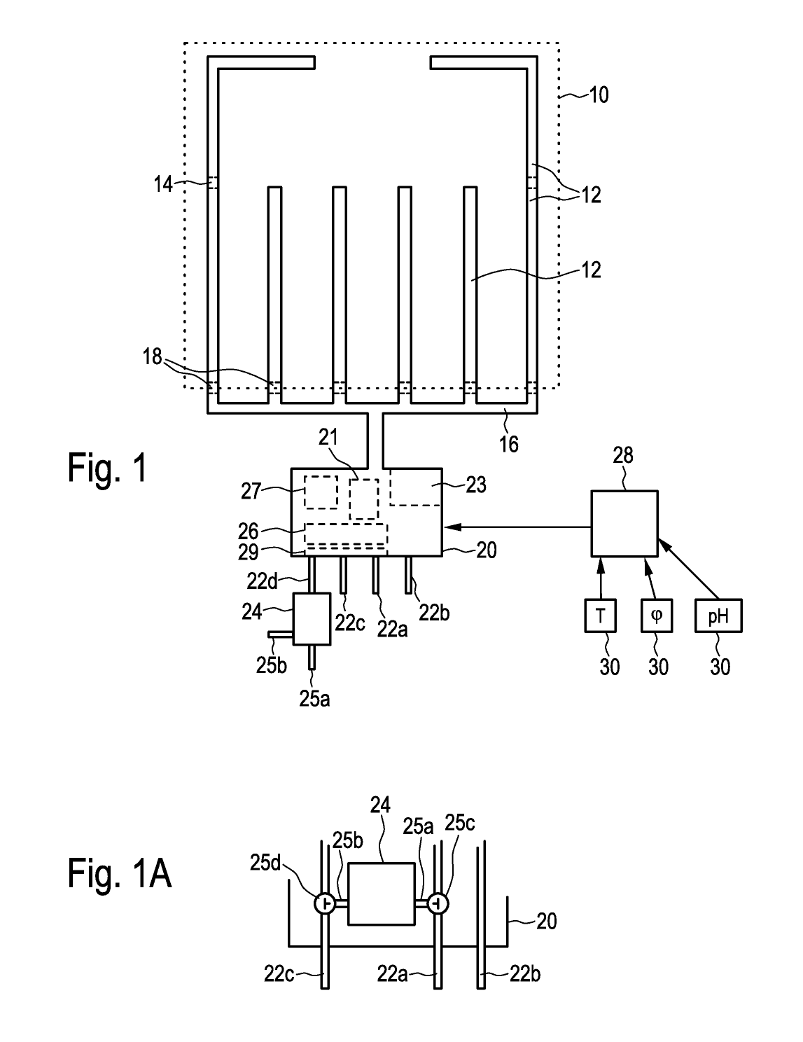

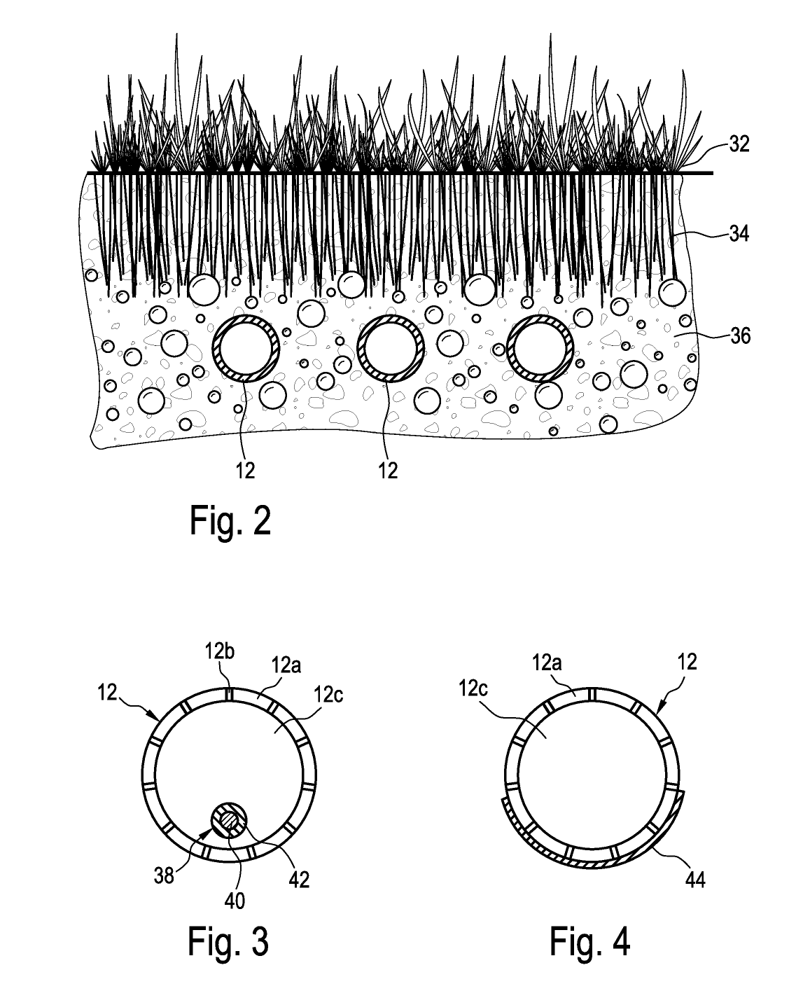

FIGS. 1, 1A and 2 will now be used as examples to describe in detail the design and operation of the system in the invention for the care of vegetation layers. The system design is essentially based on the OSMO-DRAIN® System, as described in detail, for example, in the patent documents already mentioned at the beginning, DE 101 37 147 A1 and DE 202 11 742 U1. Please refer to the full content of these two documents.

While this invention will be explained below using its preferred application to an area with vegetation layers (new system or old existing one), the invention can be used in a similar way in areas that have an artificial grass cover or ground cover of another type, quality, selection of materials, etc. Especially with artificial grass surfaces, the OSMO-DRAIN® system can have special advantages in practice (especially in connection with the heating function).

The system for caring for a vegetation layer 32, like a grass surface, athletic field, garden or parking lot or a farm or forest area, for example, generally has a large number of membrane hoses 12 that are laid roughly parallel to one another underground in a predetermined area 10. The membrane hoses 12 can, if necessary, be connected to one another via corresponding coupling elements 14 in order to serve a larger area 10 or to be able to lay the membrane hoses 12 in a more variable way. Depending on the size, circumference, profile and soil quality in the area 10, the membrane hoses 12 can be laid, at least partly, in other, i.e., non-parallel configurations.

In the example of embodiment shown, several membrane hoses 12 are connected via other coupling elements 18 to a distribution device 16 that can be designed optionally as a pipe or hose. The membrane hoses 12 are connected to a supply unit 20 via this distribution device 16. In one alternative form of embodiment, the membrane hoses 12 can also be connected directly to a supply unit 20.

In the example of embodiment shown in FIG. 1, the supply unit 20 has four connections 22a, 22b, 22c and 22d. Naturally, less than four connections or more than four are also options. These connections 22a . . . d can also be chosen in any desired combination and number from the forms of embodiment of connections described below.

A pressurized liquid, for example water, can be fed through the first connection 22a to the supply unit 20 and then finally to the membrane hoses 12. The pressurized liquid pumped into the membrane hoses 12 passes through the porous walls of the membrane hoses 12 and comes out into the surrounding earth 36 of the vegetation layer 32 and goes directly into the root area 34.

With the second connection 22b of the supply unit 20, the distribution device 16 and the membrane hoses 12 can be connected to a vacuum. With the vacuum, the membrane hoses 12 are first emptied to produce a corresponding vacuum in the membrane hoses 12. With this vacuum inside the hose, liquids and/or gases from the surrounding soil 36 push through the porous walls of the membrane hoses 12 and are suctioned off.

The supply unit 20 also contains a third connection 22c, by which compressed air or pressurized gas, in general, can be connected. This compressed air is pumped into the membrane hoses 12 through the supply unit 20 and can be used, for example, to blow out the pores 12b in the porous walls 12a of the membrane hoses 12 occasionally, to prevent clogs from the surrounding earth 36 and thus guarantee their functionality. The vegetation layer 32 can also be aerated with this compressed air, and especially supplied with oxygen.

In another embodiment, the second and third connections above, 22b and 22c, are designed as a common connection, which can be connected to a pump, for example in the form of a side-channel compressor, which has the option of operating with suction or pressure. A water trap can also be provided between the common connection 22bc and this pump to maintain a constant vacuum and protect the pump from liquids.

Lastly, the fourth connection 22d of the supply unit 20 has a device 24 for mixing gas and liquids connected to it. This device 24 has a first connection 25a to add a liquid, for example water, under pressure, and a second connection 25b to add a gas, for example air or oxygen, with or without pressure. For example, the gas can be injected under pressure into the stream of liquid in the first connection 25a. Alternatively, the gas can simply be entrained through a hole by the liquid stream. This last variation can suffice, especially when only small quantities of gas are needed and/or the plant-care areas 10 are small.

These kinds of devices 24 are known as so-called “water aerators,” for example. This invention is not limited to a special embodiment of such a water aerator.

The fourth connection 22d with the water aerator 24 connected to it is used to take a pressurized water/oxygen mixture or a water/air mixture, generally a liquid/gas mixture to the supply unit 20 and then finally to the membrane hoses 12. This water/oxygen mixture goes through the porous walls 12a of the membrane hoses 12 into the surrounding earth 36 of the vegetation layer 32 and directly out into the root area 34.

In a system in which water and oxygen can only be added separately from one another and in sequence via the first and third connections 22a, 22c of the supply unit, the aeration and gas exchange modes can dry out the root area 34 of the vegetation layers 32. This effect is increased even more when there is additional heat. To save the vegetation layers 32, they must be irrigated, if necessary at inappropriate times, which in some cases can lead to unwanted water-logging of the earth 36 and the vegetation layers 32.

In contrast to that, the water aerator 24 makes it possible to supply the vegetation layers 32 simultaneously with water and oxygen, which results in the ideal treatment of the root area 34 as needed. In particular, this is a simple way of preventing the vegetation layer 32 from drying out, the earth 36 from becoming water-logged and the root area 36 from being undersupplied.

In the embodiment in FIG. 1, the water aerator 24 is connected to the supply unit 20, i.e., connected to its fourth connection 22d. Alternatively, it is also possible to build such a water aerator 24 into the supply unit 20. FIG. 1A shows such an alternative embodiment of a supply unit 20 with a built-in device 24 for preparing a liquid/gas mixture.

In the example in FIG. 1A, the supply unit 20 is provided with a first connection 22a to add a liquid, for example water, under pressure, a second connection 22b to connect a vacuum and a third connection 22c to add a gas, for example air or oxygen, under pressure. The liquid provided via the first connection 22a can be added either directly to the membrane hoses 12 or to the first connection 25a of the water aerator 24. Similarly, gas provided via the third connection 22c of the supply unit 20 can be fed either directly to the membrane hoses 12 or to the second connection 25b of the water aerator 24. For this purpose, the first and second connections 25a, 25b of the water aerator 24 can, for example, be coupled to the first and third connections 22a, 22c via corresponding two-way valves 25c, 25d or equivalent adjustment elements.

This also provides the possibility of pumping one of the possible fluids, liquid, gas and liquid/gas mixture, from the supply unit 20 into the membrane hoses 12 and taking it to the vegetation layers 32.

Preferably, the supply unit 20 also contains one or more filters 29 for the respective stream of fluid.

A pressure regulator 21 is also provided to regulate or control the pressure of the respective fluid in the membrane hoses 12 at a predetermined value or range of values.

With this pressure regulator 21, the plant-care system can easily be adjusted to the respective plant-care range 10 and/or the respective environmental conditions. In particular, the fluid pressure can be set in such a way as to provide a uniform supply of fluid to the vegetation layers 32 over the entire plant-care range 10.

The filter 21 and/or the pressure regulator 21 can be arranged optionally internally or externally in relation to the supply unit 20.

The supply unit 20 also has a built-in tempering device 26 to temper the fluids, before they go into the distribution device 16 and the membrane hoses 16, if necessary, a power supply 23 for the tempering devices 38 of the membrane hoses 12, to be explained later, and/or a feed device 27 to feed additional materials into the stream of fluid. Potential materials are, for example, media for fertilizing, pest control, weed control, disease control and the like. The tempering device 26 can be designed for cooling, heating or optionally cooling or heating. One potential embodiment of this tempering device 26 is an inlet-control water heater, for example.

A tempering device 26, power supply 23 and/or feed device 27 can be arranged optionally inside or outside the supply unit 20.

The distribution device 16 and hence the membrane hoses 12 are connected, depending on the need, for example, by means of suitable valves, like for example electromagnetic or compressed-air-activated valves, or appropriate adjustment elements, optionally to one of the connections 22a-d of the supply unit 20. These valves and adjustment elements of the supply unit 20 are controlled, for example, by a control unit 28 in the corresponding way. The control unit 28 preferably has a storage device in which the user can store the plant-care conditions and cycles of the vegetation layers 32 he wants, so that the care is automatic. Naturally, the user can also enter control commands manually in the control unit 28 at any time to influence the function of the control unit 20 directly and/or short-term or to change the stored values.

The control unit 28 also controls the power supply 23, the tempering device 26, the feed device 27 and/or the device 24 for mixing gases and liquids.

In addition, the control unit 28 can be connected to different sensors 30, which detect environmental conditions important for the care of the vegetation layers 32, like for example the temperature T and the moisture φ of both the air and the soil, as well as the pH of the soil 36, in order to be able to match the care of the vegetation layers 32 as ideally as possible to these actual environmental conditions.

As shown in FIG. 2, the membrane hoses 12 are laid in the earth 36 under the root area 34 of the vegetation layer 32. The typical depth of the membrane hoses 12—apart from special applications—is generally between 12 and 25 cm, and at most between 15 and 20 cm, for example.

The depth, diameter, mutual distance and porosity of the walls 12a of these membrane hoses 12 can be adjusted to the soil quality and the climate conditions of the vegetation layers 32 receiving care.

If necessary, a separating device (not shown) impermeable to water can also be placed under the arrangement of membrane hoses 12, for example in the form of a film or profile section on which the membrane hoses 12 are then laid to prevent the water from infiltrating into the base of the soil.

The porous membrane hoses 12 are permeable to fluids like liquids and gases in both directions and are preferably made of a chemically and physically resistant plastic or rubber material. To guarantee that the plant-care system has a long life without maintenance, the membrane hoses 12 should be highly frost-proof, break-resistant, resistant to the plant-care materials that come with the liquid, pressure resistant, etc. In one preferred embodiment, the membrane hoses 12 are made of old tire granulate by means of an appropriate extrusion process. The membrane hoses 12 are generally designed to be flexible or bendable to make them easy and flexible to lay and store when coiled. Depending on the application, stiff membrane hoses 12 can also be used, however.

Two examples of membrane hoses 12 that can be used for such a plant-care system will now be described in greater detail using FIGS. 3 and 4.

In the first embodiment (FIG. 3), the membrane hoses 12 have a wall 12a provided with pores 12b that allows fluids (liquids and gases) to flow through in both directions and a hollow space 12c bounded by this wall 12a for transporting fluids.

The shapes of the cross sections of the membrane hoses are usually round, and especially circular, as shown in FIGS. 2 to 4. But, naturally, the invention is not limited to these forms of embodiment. Thus, for example, round cross sections with one or more flat sides or multi-cornered cross sections can be used.

A tempering device 38 can also be placed in the hollow space 12c of the membrane hose 12. This tempering device 38 basically extends over the entire length of the membrane hose 12. Preferably the tempering device 28 is designed in such a way that the membrane hose 12 can be coiled, including the tempering device 38. This can make it much easier to store, transport and install the membrane hose 12.

For example, the tempering device 38 is inserted in the hollow space 12c of the membrane hose 12. Alternatively, the tempering device 38 can also be connected firmly to one inside wall 12a of the membrane hose 12, for example, with adhesive or the like.

In the example of embodiment in FIG. 3, the tempering device 38 has an electric heat-resistant wire 40, which is designed, for example as a constantan wire and is surrounded by insulation 42. The heat-resistant wire 40 is connected to the power supply 23 of the supply unit 20 via the coupling elements 14, 18. The insulation 42 is used, on one hand, to protect the electric heat-resistant wire 40 from the fluids flowing through the hollow space 12c of the membrane hose 12 and, on the other hand, to protect these fluids and the walls 12a of the membrane hose 12 from being affected by the heat-resistant wire 40. It therefore preferably has special electrically and chemically insulating properties.

FIG. 4 shows a membrane hose 12 in a second example of embodiment. The same components are marked the same as in FIG. 3, and a more detailed description of them is not repeated.

The membrane hose 12 in this example of embodiment is different from the membrane hose 12 shown in FIG. 3 in that its wall 12a is partly closed. For example, a seal 44 is provided on the outside of the wall 12a, but it can also or alternatively be provided on the inside of the wall 12a or directly in the pores 12b.

The seal 44 is preferably provided on only one side of the membrane hose 12, as shown in FIG. 4. The side of the membrane hose 12 with the seal 44 is then laid pointing down into the soil 36 when the plant-care system is installed. This is an advantageous way of preventing any water and/or air that should go through the membrane hoses 12 to the vegetation layers 32 from being pushed down out of the membrane hoses 12. Instead, the fluids are mainly pressed up and out of the membrane hoses 12 and can thus be fed more quickly and safely to the root area 36 of the vegetation layers 32. In other words, the drainage of the fluids can be reduced by gravitation and the capillary action in the direction of the root area improved. This is an advantage and can save water for the whole system.

Partly closing the wall 12a of the membrane hoses 12 can also result in improved flow behavior of the fluids through the membrane hoses 12. In particular, the fluids can be transported at a more even and constant speed through the membrane hoses 12, which results in more even distribution of the fluids over a large plant-care area 10. This effect also applies especially when laying membrane hoses 12 in uneven terrain, since height differences and inclines can also be overcome better at lower fluid pressures.

In the example of embodiment in FIG. 4, up to roughly 50% of the wall 12a can be closed with the seal 44. In general, closing the wall 12a of the membrane hoses 12 with percentages from roughly 20% to roughly 65%, preferably from roughly 35% to roughly 55%, can be an advantage.

The partly closed wall 12a is not limited to the distribution of the seal 44 in FIG. 4. Alternatively, it is also conceivable to coil the membrane hose 12 in a spiral with sealing tape 44 or coil the membrane hose 12 with sealing tape 44 at regular or irregular intervals.

The membrane hose 12 in FIG. 4, unlike the membrane hose 12 shown in FIG. 3, contains no tempering device 38. But, of course, such a tempering device 38 can also be built into the membrane hose 12 shown in FIG. 4.

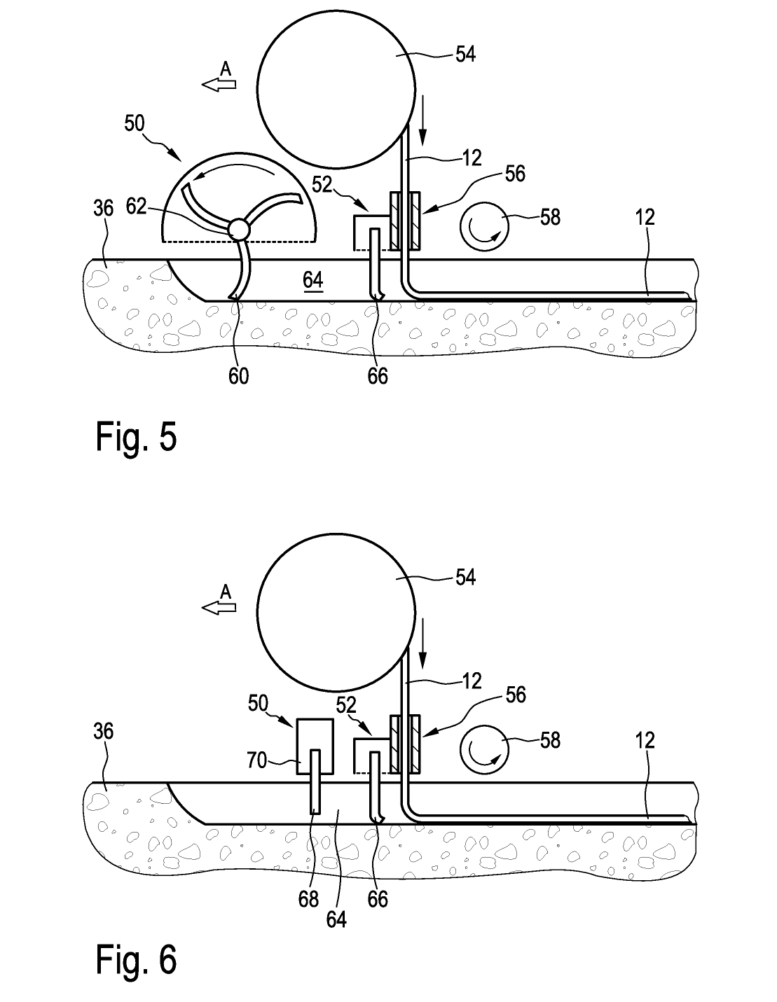

Now, two possible devices for laying membrane hoses 12 underground, and hence installing the plant-care systems in the invention described above, will be described with reference to FIGS. 5 and 6.

The device shown in FIG. 5 for laying a membrane hose 12 underground contains, in particular, a cutting device 50, a widening device 52, a holding device 54 for holding the membrane hose 12 to be laid, an insertion device 56 and a roller 58. These components 50-58 are arranged in the direction of movement (arrow A) one after another in this sequence in the laying process. Preferably, these components 50-58 are mounted on a common device, for example a self-propelled device, or a device that can be attached to a vehicle like a tractor, tractor unit or the like, in order to be able to lay the membrane hose 12 in one step.

As shown in FIG. 5, the widening device 52 and the insertion device 56 are preferably designed to be integral. This means that they are designed as one unit, for example, or connected solidly to one another. In particular, the two devices 52 and 56 should be placed as close as possible one after another.

In the side view in FIG. 5, only one of the components mentioned 50-58 used to lay an individual membrane hose 12 can be seen. Naturally, in one preferred form of embodiment of the invention, several membrane hoses 12 can simultaneously be laid parallel, so that the components 50-58 are also laid parallel to one another, and components 50-58 are provided in the corresponding number parallel to each other (in the direction perpendicular to the plane of the drawing next to one another) on the device. Since components 50-58 arranged parallel are basically built the same, for the sake of simplicity, only the device for laying an individual membrane hose 12 will be described below.

The component furthest up front in the direction of movement A, the cutting device 50, contains several (for example, three) rotating cutting knives 60, which are placed on a common rotation shaft 62, preferably at a fixed angle. These cutting knives 60 are used to cut a slit 64 in the soil of the vegetation layer 32. The cutting device 50 is positioned and the cutting knives 60 are dimensioned so that the slit 64 is at least as deep as the installation depth of the membrane hose 12 to be laid. The width of the cutting knives 60 (crosswise to the direction of movement A) is less than or equal to the diameter of the membrane hose 12 to be laid, so that any vegetation layer 32 there is damaged as little as possible.

As shown in FIG. 5, the cutting knives 40 are designed to be bent roughly in the shape of a small scythe, and its curve in the slit 64 in relation to the direction of movement A points to the back. This can prevent stones and the like from being pushed up to the surface of the plant-care area 10, and the pressure from the cutting knives 60 on the earth is mainly downward, so as to reduce the lateral compaction of the soil 36.

The slit 64 is cut by a combination of the rotary movement of the rotation shaft 62 with the cutting knives 60 mounted on it and the forward movement of the cutting device 50 in the direction of movement A.

After the slit 64 is cut by the cutting device 50, the slit 64 is widened by a stationary widening knife 66 on the widening device 52 to a width basically equal to the diameter of the membrane hose 12 to be laid. The widening knife 66 has a penetration depth into the earth that corresponds to the insertion depth of the membrane hoses 12 being laid. As shown in FIG. 5, the lower end of the widening knife 66, in relation to the direction of movement A, is preferably angled back to prevent stones and the like from being brought to the surface.

The holding device 54 has a coiler on which a membrane hose 12 to be laid is coiled. Using a guide element in the insertion device 56, the membrane hose 12 is uncoiled from the coiler and inserted in the slit 64 made wider by the widening knife 66. The membrane hose 12 can be put into the slit 64 solely by the movement A of the insertion device 56 (and the other components 50-58), but an additional conveyor can also be provided as an option.

After the membrane hose 12 is inserted into the slit 64, the slit 64 is closed back up again by the trailing roller 58.

Although not shown, the device for laying a membrane hose 12 underground can also have a tank for additional media, like sand, fertilizer, seed and the like, for example, from which the additional media can be placed in the slit 64, and/or another holding device for a water-impermeable separating device, as well as an insertion device for removing the separating device from the other holding device and inserting the separating device into the widened slit, before the membrane hose 12 is inserted.

The details above and others on the design and operation of this device for laying membrane hoses 12 will be seen from studying EP 1 811 218 A1 by the inventor. Please refer to the full contents of this publication.

FIG. 6 shows a device for laying membrane hoses 12 in an alternative example of embodiment. The same or similar components are marked with the same reference numbers as in FIG. 5, and the description of them is not repeated.

The installation device in this example of embodiment differs from the device above in FIG. 5 in its type of cutting device 50. While the cutting device 50 in FIG. 5 is designed with several rotating cutting knives 60, the cutting device 50 in FIG. 6 has a vertically driven cutting knife 68 with a corresponding lifting drive 70. Optionally, two or more cutting knives can be provided one after another and/or next to one another in the direction of movement A.

As a comparison of FIG. 6 with FIG. 5 shows, the installation device in FIG. 6 has a shorter structural length in the direction of movement A. This in turn has the advantage that this shorter installation device can also radiate. Depending on the terrain and the superstructures in the plant-care area 10, this can make it easier to lay the membrane hoses 12 under the ground, make it possible to lay membrane hoses 12 basically horizontally and expand the possibilities for using the laying device.

But, of course, the membrane hoses 12 built according to this invention can also be installed with other devices and/or manually.

These and other examples of the invention illustrated above are intended by way of example and the actual scope of the invention is to be limited solely by the scope and spirit of the following claims.

1. A method of caring for vegetation layers, in which a fluid is added to vegetation layers by means of at least one membrane hose laid underground, characterized by the fact that the fluid is a liquid/gas mixture.

2. The method in claim 1, characterized by the fact that the liquid/gas mixture is produced by mixing a gas and a liquid.

3. The method in claim 2, characterized by the fact that the liquid/gas mixture is produced by injecting a gas into a stream of liquid.

4. The method in claim 2, characterized by the fact that the liquid/gas mixture is produced by entraining a gas through a stream of liquid.

5. The method in claim 1, characterized by the fact that the liquid/gas mixture is a water/air mixture or a water/oxygen mixture.

6. The method in claim 1, characterized by the fact that additional materials are added to the liquid/gas mixture.

7. The method in claim 1, characterized by the fact that the liquid/gas mixture is tempered before being added to the vegetation layers.

8. The method in claim 1, characterized by the fact that the liquid/gas mixture is tempered basically over the entire path where it is added to the vegetation layers.

9. The method in claim 1, characterized by the fact that the pressure of the liquid/gas mixture is regulated or controlled at a predetermined value or range of values.

10. A device for caring for vegetation layers, with at least one membrane hose laid underground to inject fluids into the vegetation layers and a supply unit connected to at least one membrane hose characterized by the fact that the supply unit has at least one device for preparing a liquid/gas mixture.

11. The device in claim 10, characterized by the fact that the device for preparing a liquid/gas mixture is a device for mixing gases and liquids.

12. The device in claim 10, characterized by the fact that the device for preparing a liquid/gas mixture is built into the supply unit or the supply unit has a connection to connect the device for preparing a liquid/gas mixture to the supply unit.

13. The device in claim 10, characterized by the fact that the device for preparing a liquid/gas mixture is designed so that it also offers the option of preparing only a liquid or only a gas.

14. The device in claim 10, characterized by the fact that the liquid/gas mixture is a water/air mixture or a water/oxygen mixture.

15. The device in claim 10, characterized by the fact that the supply unit also has at least one connection selected from a connection to add a liquid under pressure, a connection to add a gas under pressure and a connection to remove liquids and/or gases by vacuum in or out of at least one membrane hose.

16. The device in claim 10, characterized by the fact that the supply unit has a tempering device for tempering the fluid added to at least one membrane hose and/or at least one membrane hose is provided with a tempering device basically over its entire length.

17. The device in claim 10, characterized by the fact that a feed device is provided to feed additional material to the fluid run through at least one membrane hose.

18. The device in claim 10, characterized by the fact that the supply unit and/or the device for preparing a liquid/gas mixture has a pressure regulator to regulate or control the pressure of the fluid injected into the vegetation layers.

19. The device in claim 10, characterized by the fact that the supply unit and/or the device for preparing a liquid/gas mixture has a filter device to filter the fluid injected into the vegetation layers.

20. The device in claim 10, characterized by the fact that at least one membrane hose is connected to the supply unit via a distribution device.
